(19) United States
(12) Patent Application Publication
(10) Pub. No.: US 2004/0117280 A1
(43) Pub. Date: Jun. 17, 2004

(54) Financial document automation system and method

(76) Inventors: Rosemary Klee, Cleveland Heights, OH (US); Rod D. Laird, Mentor on the Lake, OH (US); Dan R. Petricig, Cleveland, OH (US); Arthur M. Trenton JR., Mentor, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/318,342

(22) Filed: Dec. 12, 2002

(51) Int. Cl. G06F 17/60

(52) U.S. Cl. 705/35

(57) ABSTRACT

A process for automatically creating a geographic region-specific financial document pertaining to a financial product in real time such that all clauses present therein are effective. The process includes the steps of providing a computer database including at least one master financial document pertaining to a specific financial product, the master financial document having a plurality of document clauses, each of the clauses containing information associated with a different one of a plurality of geographic regions, selecting the master financial document associated with the specific financial product from the database including the master financial document, providing information regarding a desired one of the plurality of regions and selecting all document clauses pertaining to the specific financial product and to the desired region to be used in the selected master financial document and assembling the clauses into the document to make a completed financial document. The process is performed by software residing on a server that can be accessed over a network, including the Internet. An advantage of the invention is that it creates financial documents, such as financial disclosure documents for financial products, that contain only the clauses needed for the specific document requested; there is no need for attaching alternate clauses to a document or for maintaining an inventory of printed documents pertaining to specific geographic regions.

### BACKGROUND

The present invention relates to document processing systems and, more particularly, to document processing systems for creating and delivering documents pertaining to financial and investment products automatically and in real time.

The banking industry has undergone a rapid expansion with respect to the kinds of financial products that may be offered by a bank. For example, banks today offer a wide variety of deposit products such as interest bearing checking accounts, checking accounts with automatic overdraft protection, savings accounts and certificates of deposit with varying deposit amounts, interest rates, and maturity terms. Banks also offer a variety of lending products such as signature loans, mortgages, and home equity lines of credit. In addition, Banks offer a wide variety of retirement products such as individual retirement account (“IRA”) programs and other retirement vehicles.

In addition, regulatory changes have allowed banks to expand their markets to a national scale, so that a bank located in one state or banking district may offer its financial products to customers anywhere else in the country. Such nationwide banking is accomplished both by providing branch banks throughout a wide geographic area and by providing customer access to bank products by means of information networks such as the Internet.

State and federal banking laws impose requirements on each type of banking product. These requirements necessitate the bank providing a prospective customer with disclosure documents that pertain specifically to the particular financial product the customer wishes to obtain. Moreover, the requirements for a particular disclosure document may vary from product to product as well as from state to state, and in some instances, the disclosure document requirements vary within a state. In some instances, the differences pertain to specific values, such as fees assessed by the bank for a particular product, interest rates, minimum balances that must be maintained and the minimum amount that must be deposited in order to qualify for a product. Furthermore, the required content for documents that are collateral to the providing of banking services, such as privacy policy statements, also varies from one region to another.

Most banks have dealt with this situation by printing disclosure documents (including privacy policy statements) appropriate for each financial product offered and including the requirements of each governmental district within which such products are offered. Accordingly, the permutation of products and regions has necessitated the creation and maintenance of extensive inventories of disclosure documents by banks in order to provide customers with the appropriate disclosure documentation for a particular product within a particular region. Another solution employed by banks is to provide a printed disclosure document in which certain clauses are marked as being effective only in certain geographic regions, or to provide added clauses that indicate that they supercede and replace clauses appearing earlier in the document.

In addition to governmental requirements, certain values associated with financial products, such as an assessed (in the case of a lending product) or paid out (in the case of a deposit product or retirement product) interest rate change frequently. Such changes require either that the entire inventory of disclosure documents that pertain to that particular interest rate become obsolete and are disposed of, or the disclosure documents contain blank spaces that are filled in manually by a bank representative at the time of application for the financial product.

Accordingly, there is a need for a system for creating and maintaining disclosure documents for a variety of financial products that are applicable to a wide variety of geographic regions that does not require the creation and maintenance of a large inventory of printed documents, or the disposal or modification of stored physical documents in response to changes in fees assessed, interest rates, minimum balance requirements or privacy policy statements. There is also a need for a system for creating and maintaining disclosure documents for financial products that allows changes to be made quickly and permanently and that allows such changes to apply to a selected number of disclosure documents.

### SUMMARY

The present invention is a system and process for creating financial documents, such as disclosure documents, that are tailored to a specific financial product desired by a customer and to the specific geographic region where the customer is located. The invention creates the financial documents automatically in response to a request and in real time, thereby eliminating the need for maintaining an extensive inventory of printed financial documents. Since the financial documents of the present invention are created electronically, such documents can be transmitted instantaneously to any location, whether it be a bank branch, bank back office operation or a personal computer of a customer.

In one embodiment of the invention, a process for automatically creating a financial document pertaining to a financial product includes the steps of providing a computer database including at least one master financial document pertaining to a specific financial product, the master financial document having a plurality of components having text clauses therein pertaining to financial information specific to a particular region or regions (i.e., a particular pricing district or districts), each of the clauses may contain tag place holders pertaining to specific financial values, selecting the master financial document associated with a specific financial product from the database including the master financial document, providing information regarding a desired region, and selecting all components pertaining to the specific financial product and to the desired region to be used in the selected master financial document and inserting selected financial values into the clauses at the tag place holders to make a completed financial document. The benefit of the process of this embodiment is that the resultant disclosure document pertains exclusively to a specific financial product provided at a specific region and contains current financial values, such as fees, rates and minimums. Therefore, all of the clauses present in the assembled document are effective and pertain to the product and to that specific region.

The system of the present invention preferably includes a web server that interfaces with either an intranet client (e.g., bank employee at a bank branch) or an Internet customer by way of a web server and an application server for hosting, for example, a general application web site for the bank. The application server for the general application web site communicates with a second web server that communicates with an application server that houses software for receiving a financial disclosure request and generating a command for a specific master document. A library server communicates with the application server and includes software for receiving a request from the application server software for the specific master document stored in a database. The library server software also communicates with bank legacy system data bases to obtain such specific financial values such as fees, rates and minimum balances.

Software located at the web server and application server for the general purpose web site, in response to a customer request for a specific product, sends an appropriate command to the second web server. This command includes information pertaining to the specific financial product as well as the region in which the customer resides. This command is received by the second web server, which identifies it as a request for a financial product document, such as a disclosure document, and forwards the command to the application server. The application server software receives the request for the specific financial product and forwards that request to the library server. The library server then returns the master disclosure document, which includes all components pertinent to the requested disclosure document. In addition, the library server retrieves appropriate pricing information for that product.

The application server software examines each component to determine whether that component is appropriate for insertion in the final version of the financial document. Each component includes a text clause as well as tags identifying such attributes as effective date of that clause, the specific financial product or products to which that clause pertains and the region in which that clause is effective. Accordingly, the application server selects from among all of the components provided to it by the library server as part of the master document only those components that have an effective date range that includes the date specified in the request and only those components that pertain to the specific region where the customer resides. Those components are then assembled into the final financial document and the document is transmitted to the web server for the general purpose web site. In turn, the web server transmits the completed document to the bank customer where the completed document is displayed and printed, if desired. The process for a bank employee is similar to the foregoing, except that the computer used by the bank employee is part of an intranet that communicates directly with the second web server.

Another advantage of the system of the present invention is that the creation and editing of documents and document clauses can be done electronically. The editing software resides on the authoring workstation and enables an editor to change a component, including the body text of a component, easily using conventional word processing techniques. The system and method of the present invention also enables an editor to create an amendment to a document component that notifies customers of upcoming changes in, for example, rates and fees. Such person logs into the system and his or her name is checked against the approved list of authors. If that individual is on the list, he or she is permitted to retrieve and document components and create amendments. Editing and assembling the edited components is done on the application server.

In the amendment process, an approved editor first retrieves a working master document that contains a component to be edited, and opens that working master document, which displays all components of that working master document in a window on a computer screen. A working master document is not available for intranet or Internet access. The editor then provides, in a body text field between body tags, the text of the amended clause of the component. Tag placeholders are inserted in the text to indicate placement of financial values such as fees, rates and minimums. The editor then inserts between the effective date tags an effective date by which that text automatically will be included in the relevant document. Additional information, called locators, which includes information such as the type of financial product and pricing or geographic region to which the component pertains, may be added or amended by way of a locators dialog box. The amended component is then forwarded as part of a published draft master document simultaneously to a list of reviewers selected by the author. Each of the reviewers is required to review the edited component and indicate approval. It is only when all of the reviewers have approved of the edited component that that component is stored as a “published approved component” by the editor and thereafter is included in the published approved master document for the financial disclosure document to which it pertains as of its indicated effective date.

On the other hand, if a reviewer disapproves of the component, that component is returned to the editor with the disapproving reviewer's comments. The component may be edited in response to the comments and again is forwarded to a selected list of reviewers for approval. This iteration continues until all reviewers approve of the component. Typically, the reviewers may represent various entities in the bank such as product managers, legal, regulatory and marketing.

Preferably, the master document and components thereof are transmitted and stored in extensible mark up language (“XML”), which can be handled by a wide variety of software. Furthermore, the requests from the client or bank branch are received by the web server in hypertext transfer protocol (“HTTP”) format, which is compatible with XML.

The benefit of the editing process is that editing a particular component that is used in a number of disclosure documents need only be performed once. Thereafter, all financial disclosure documents that require that particular edited component will be constructed automatically with that edited component upon the effective date of that component. Another advantage of the invention is that, if it is necessary to reconstruct a particular disclosure document that was used on a particular date, the command is given for that particular document on that desired date. The system will than retrieve the master document and all components, then selectively include the text clauses of those components having the desired effective date.

The master documents for a product grouping consist of those components for a particular financial product that contain text clauses that are the same for every geographic or pricing region, as well as all components that contain text clauses that apply to specific geographic and pricing regions. Components are tagged with locators that indicate the specific geographic or pricing region to which they apply. Certain of the text clauses contain tag place holders for fee, rate or balance values.

It should be noted that, while the present invention is described with respect to disclosure documents that are required to be transmitted to a customer of a bank who applies for a financial product from that bank, the invention may be employed with other types of documents, such as privacy policy statements, as well as documents that pertain to investment products, such as securities trading and opening investment accounts. Consequently, the term “financial document” as used herein applies to any such documents that may be employed by a financial institution in the course of providing financial, investment and insurance services.

Accordingly, it is an object of the present invention to provide an automated system for the creation and editing of disclosure documents and disclosure document clauses. It is also an object of the invention to provide a system that is accessible over networks such as the intranet of a particular financial institution and an external network such as the Internet.

Other objects and advantages of the present invention will be apparent from the following description, the accompanying drawings and the appended claims.

### BRIEF DESCRIPTION OF THE DRAWINGS

FIG. 1 is a schematic diagram of a system that incorporates an embodiment of the automated disclosure system of the present invention;

FIG. 2 is a flow chart showing the creation of a disclosure document by the system and process of the present invention;

FIG. 3 is a flow chart depicting the process for creating and editing a document component of the present invention;

FIG. 4 is a schematic representation of XML components stored in the XML content database shown in FIG. 1;

FIG. 5 is a schematic representation of a component having a text clause with associated tags;

FIG. 6 is a window showing the structure of an XML document of the present invention;

FIG. 7 shows an editing window of an XML master document of the present invention;

FIG. 8 shows a locators dialog box pertaining to a component of the master document of FIG. 7;

FIG. 9 shows the editing window of FIG. 7 in which locators tags appear in the component and tag place holders appear in the text clause;

FIG. 10 shows the editing window of FIG. 7 in which an amendment to a component is being made;

FIG. 11 shows the amendment section within the component of the master document of FIG. 7;

FIG. 12 shows a window of the present invention that displays the details of the state of a document;

FIG. 13 shows a window of the present invention that displays a sample electronic request form that sets forth locator and text information; and

FIG. 14 shows a window of the present invention that displays a form setting forth statement text and locator information for a document.

### DETAILED DESCRIPTION

### System Overview

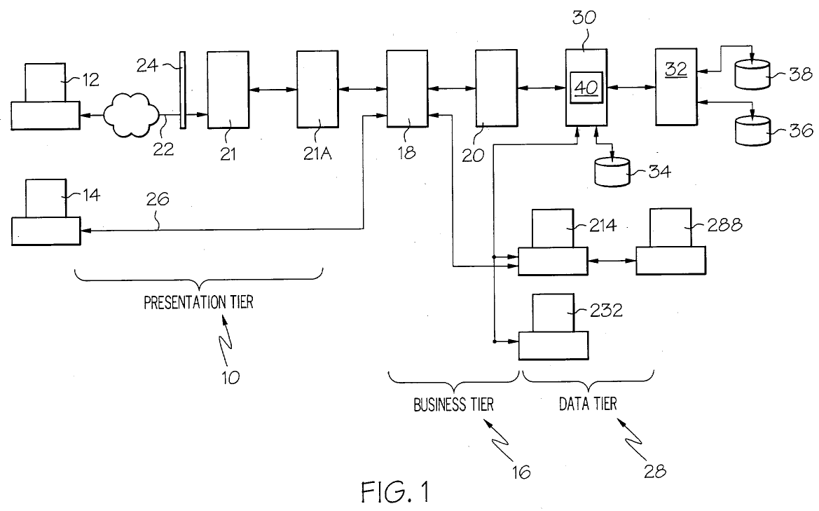

The system of the present invention is shown schematically in FIG. 1. In order to provide an available, reliable, scalable and secure document management system, the present invention utilizes a distributed architecture consisting of several tiers. The presentation tier 10 consists of a personal computer 12 that may be located at the home of a bank customer and a terminal 14 that may be located at a bank branch or a back office department. In addition, although not shown in FIG. 1, the presentation tier may include a kiosk with a touch screen, automatic teller machine (“ATM”), personal digital assistant (“PDA”) or other graphical user interface devices that are commonly known.

The middle or business tier 16 consists of a web server 18 and an application server 20. A web server 21 receives document requests from the personal computer 12 over the Internet 22 and through the standard firewall 24 of the bank. Web server 21 passes the document request to application server 21A, which passes the document request to web server 18. Alternately, the web server 18 receives document requests over an intranet 26 from the terminal 14 at a bank branch.

The application server 20 contains the software that is adapted to receive a document request from the presentation tier 10 and retrieve specific documents and document clauses from the data tier 28. The data tier 28 includes a library server 30 and a database server 32. The library server 30 includes a database 34 that includes the master documents for all of the financial products to be offered by the bank and includes all clauses to be used in all regions. The database server 32 includes a database 36 that contains pricing information regarding all of the products to be offered and a database 38 containing meta data that, as will be explained below, pertains to the attributes of the various clauses stored in the database 34.

Communication between the computers 12, 14 of the presentation tier 10 and the web server 18 of the business tier 16 is by means of hypertext transmission protocol (“HTTP”). The web server 18 serves out the static hypertext mark up language (“HTML”), cascading style sheet (“CSS”), dynamic HTML (“DHTML”) and extensible style sheet language (“XSL”) files when requested by a customer or bank employee to do so. The web server 18 also invokes Java servlets on the application server 20 to provide DHTML page generation. The Java servlets on the application server 20 implement and encapsulate the creation of financial documents.

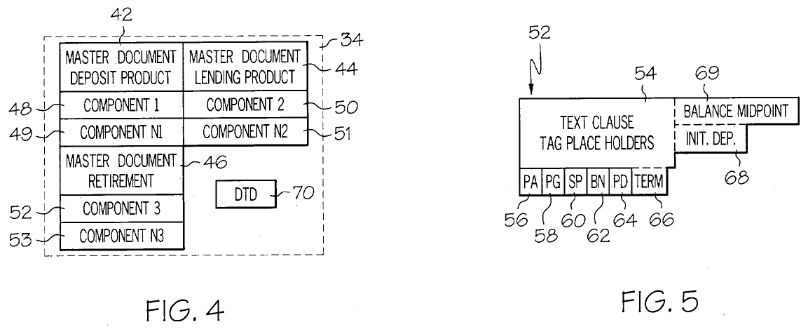

The library server 30 of the data tier 28 includes document management software such as Documentum enterprise document management software (available from Documentum, Inc., Pleasanton, Calif.). The document management software 40 controls access to the database 34. Database 34 includes XML documents representing master documents for each financial product offered by the relevant financial institution. In the shown embodiment, the documents are categorized into three broad types: deposit products, lending products and retirement products. A deposit product may be a disclosure document for a demand deposit account, passbook savings account, checking account or interest-bearing checking account. A lending product may be a disclosure document pertaining to a home equity line of credit, mortgage or signature loan. A retirement product may be a disclosure document for an individual retirement account (“IRA”). As shown in FIG. 4, these documents are stored within document root elements 42 (deposit product), 44 (lending product) and 46 (retirement product) in database 34 in XML format. Each of the root elements 42, 44, 46 includes attributes that name the component, set forth the type of component (the specific financial product) and the effective date of the component. Such master documents 42-46 consist of those components that contain text clauses that are the same for all products in all regions of the bank's market, as well as those clauses that apply to specific geographic or pricing regions.

Database 34 also includes components 48, 49, 50, 51, 52, 53 that contain language specific to a particular product or region. Each of the components 48-53 includes tags (see also FIG. 5) that indicate the product area (pa) 56, indicating whether the component pertains to a deposit, lending or retirement product; product group (pg) 58, indicating whether the product group is, for example, a checking product, certificate of deposit or retirement account (e.g., IRA account); sub-product (sp) 60, indicating a product identifier, which may be a number code, letter code or alphanumeric code, for a unique product offering within a product group; bank number (bn) 62, indicating a number for a specific bank; and pricing district (pd) 64, indicating a number for a specific geographic market segment that is near the customer in question. In addition, for CDA (certificates of deposit) and REA (retirement account) product groups, additional tags are added for the term of the product (term) 66, indicating for example, the term of the certificate of deposit requested. Additional examples of tags include an initial deposit amount (init_dep) 68 that indicates a specific initial deposit for such products and a balance midpoint 69. Tags 66, 68 and 69 are tag place holders that indicate the location of a specific value (e.g., initial deposit amount) that is inserted into a text clause from database 36 (FIG. 1).

The document handling software 40 (see FIG. 1) includes a single document type definition (“DTD”) file to control the XML structure for all disclosure documents. The DTD definitions for the various disclosure documents are stored in this file, shown as file 70 in database 34 (see FIG. 4). Consequently, all disclosure documents generated by the system of the present invention will share the same basic XML structure. The only significant difference in structure for the disclosures generated by the system will be the root XML element that will be unique to describe the specific type of disclosure (i.e., deposit, lending or retirement); that is, documents 42-46 in database 34.

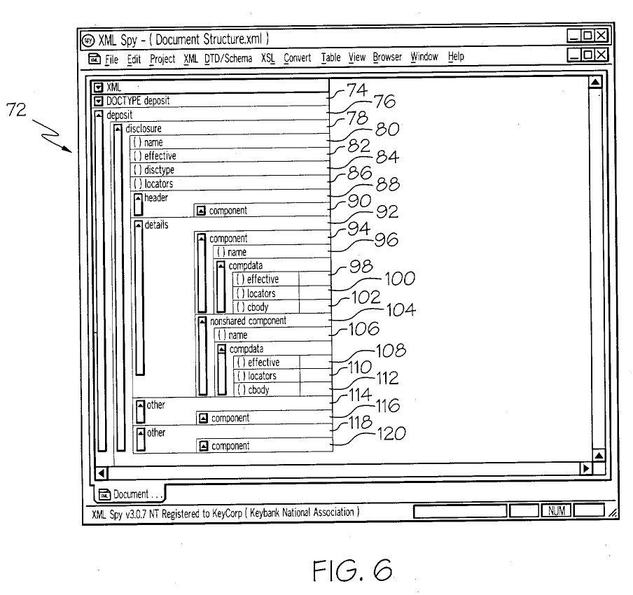

As shown in FIG. 6, a DTD 72 for a disclosure document of the present invention that pertains to a deposit product is shown. Line 74 contains an XML instruction to locate the DTD 72. The root element is displayed on line 76 and indicates that a deposit document is requested. Line 78 indicates that a disclosure shall have the format listed in the DTD 72. Line 80 lists the name of the disclosure, line 82 the effective date, line 84 the disclosure type (e.g., electronic funds transfer disclosure), line 86 the specific geographic regions and product identifiers to which the disclosure pertains, and line 88 sets forth a header for the particular disclosure document. The component in line 90 is a header that may be made up of one or more shared or nonshared components, or a combination of shared and nonshared components.

The details component is shown in box 92 and includes a shared component 94. A shared component 94 is a component of a document that has application in a wide variety of documents. The shared component also includes a name on line 96, and component data such as the effective date in line 98 geographic locators in line 100 and a text body in line 102. Line 104 indicates a non-shared component, which is a component whose use is limited to the master document in which it resides. The non-shared component also has a name in line 106, and component data such as its effective date in line 108, geographic locators in 110 and a text body in line 112. All components are subject to the editing procedures of the present invention that will be discussed in detail below. Line 114 indicates the existence of an “other” component, shown on line 116, that has a similar structure as components in lines 94 and 104. Line 118 indicates a footer component that may comprise a statement placed at the bottom of a page of the disclosure document to be constructed, a bank logo, or other object. The footer component also includes component identifying information shown compressed in line 120.

The arrangement of text clauses pertaining to components 90, 94, 104, 116, 120 of the DTD 72 are displayed in the order that they will appear in the disclosure document. Of these components, components 90, 94, 104 may be rearranged by the editor as desired, as is discussed below.

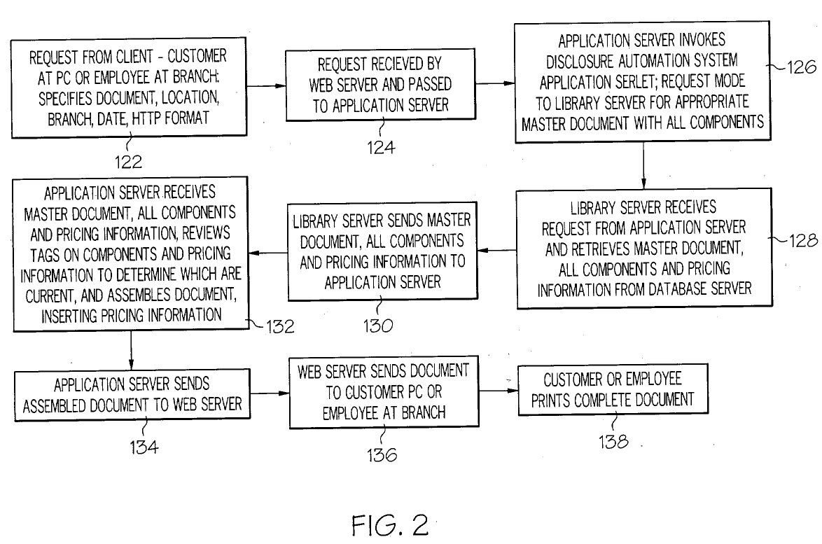

The operation of the system of the present invention in creating a financial disclosure document will now be described with reference to FIGS. 1 and 2. When a bank employee at a bank branch computer 14, or in the alternative, a bank customer at that customer's personal computer 12 wishes to obtain a financial disclosure document pertaining to a specific bank product, the software resident in computers 12, 14 generates a request in HTTP format. This request contains locator information of the type described above and shown schematically in FIG. 5 with respect to tags 56-68. As shown in FIG. 1, the request is transmitted by means of an intranet 26 or application server 21A to the bank web server 18. The Web server 18 receives the request from the client or customer, as indicated in box 122 in FIG. 2. The web server 18 receives the request and, as shown in box 124, forwards the request to the document assembling software resident in the application server 20, as indicated in box 126. The application processing software in the application server 20 generates a query or request that is transmitted to the document handling software 40 in library server 30. As indicated in box 128, the library server 30 receives the request from the application server and retrieves the master document 42 (for example) all components pertaining to that particular product and pricing information from the database 36.

The library server 30 receives the pricing information from database 36 through database server 32 and the necessary meta data from database 38 to enable the document handling software 40 to locate the appropriate XML content in database 34. The library server 30 sends the master document information and pricing information to the application server 20, as indicated in box 130. The application server receives this information as a data stream. A SAX (“Simple Application processing interface for XML”) parser is created to process the XML content returned by the query from the library server 30. The SAX parser examines the stream of XML content in real time and signals the beginning and end of each XML element, the attributes that each element contains and the content within each element.

As the information is processed by the SAX parser, the locator elements 86, 100, 110 for each of the components 90, 94, 104, respectively (see FIG. 6) are evaluated to determine whether they match the information provided in the HTTP request. If the match fails, the content for that component is not included in the output stream. This step is indicated in box 132 in FIG. 2. In the event that a pricing data element (tag pd 64 in FIG. 5) is encountered, a real time look up occurs to the pricing information database 36. The pricing information database 36 contains such information as current rate, fee and APY (“annual percentage yield”) data for the requested product set. As a result, the present invention allows current pricing data to be inserted dynamically in the disclosure content stream, thereby enabling pricing information to be updated and changed instantaneously.

Once the selection process of box 132 has been completed, the application server 20 (see FIG. 1) sends the assembled document to the web server, as indicated in box 134. The application server 20 will generate either a complete web page or an HTML (“hypertext mark up language”) segment, as indicated in box 134, and is transmitted to the customer at personal computer 12 or bank branch 14 by web server 18, as indicated in box 136. As indicated in box 138, the recipient of the web page or HTML segment may then print the completed document.

The advantage of the system and process of the present invention is that documents are created dynamically and in real time in response to requests for specific disclosure documentation. The documents created are tailored for a specific product for use in a specific geographic location. Consequently, the disclosure documents created do not require or include unnecessary clauses that, for example, may be applicable in other geographic locations or applicable to other banking products.

### Document Creation, Editing and Publishing

The following discussion describes the aspect of the present invention related to the process for creating or editing a component of a disclosure document such as a master document 42-46 or a component 48-52 thereof depicted schematically in FIG. 4, and publishing that document for use in a disclosure document. Since the document components are stored in XML format, the process incorporates a commercially available XML editor such as XMetaL, provided by Corel Corp. of Ottawa, Ontario Canada.

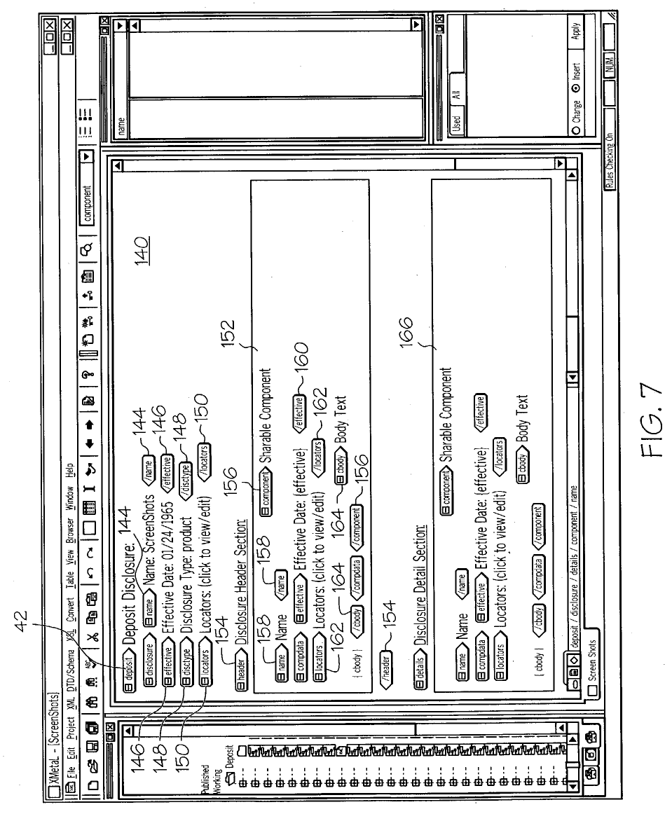

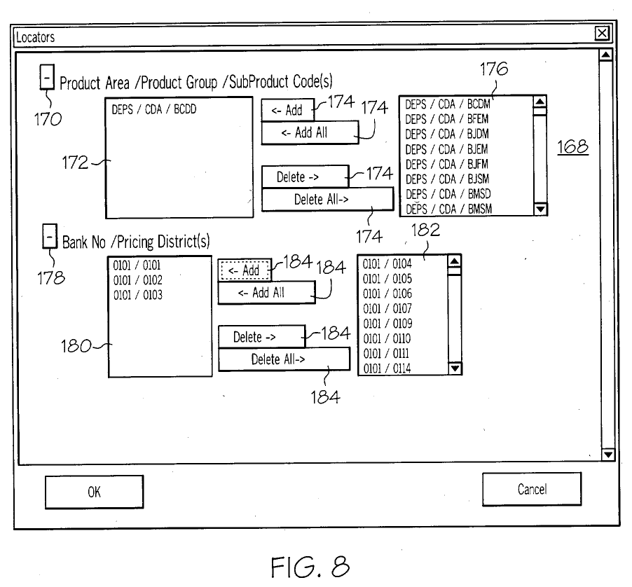

As shown in FIG. 7, the editing software displays the components of a master document as a configurable entity. Consequently, the components appear in a window 140 that displays the document product group name at tag 142, master document name (e.g., “personal checking”) at tags 144, effective date of the master document at tags 146, disclosure type at tags 148 and locators at tags 150. The locators tags 150 indicate a dialog box shown in FIG. 8. The header component 152 of the disclosure document is shown at tags 154. The header component 152 is a sharable component, as indicated at tags 156. As stated previously, this means that component 152 may be used by referencing into more than one master document. The name of the component 152 is indicated at tags 158, effective date at tags 160 and locators at tag 162. The text clause or body text of component 152 is located between tags 164, indicating the content of the component. The same structure applies for component 166, which may pertain to another text clause of the master document, or for example, to a footer. An editor can change the content of a component by placing a cursor at the desired location and making the appropriate insertion or deletion. The order of components within the master document is determined by the editor, who simply clicks and drags a component to the desired location.

As shown in FIG. 8, when a “click to view/edit” button, such as between tags 150 (FIG. 7) is activated, dialog box 168 is launched. Box 168 includes a button 170 that opens up a window 172 that enables product areas, product groups and subproduct codes to be added by means of buttons 174 from a menu in window 176. Similarly, button 178 opens up window 180 that enables bank numbers and pricing districts to be added from a menu in window 182 or deleted, by actuating buttons 184.

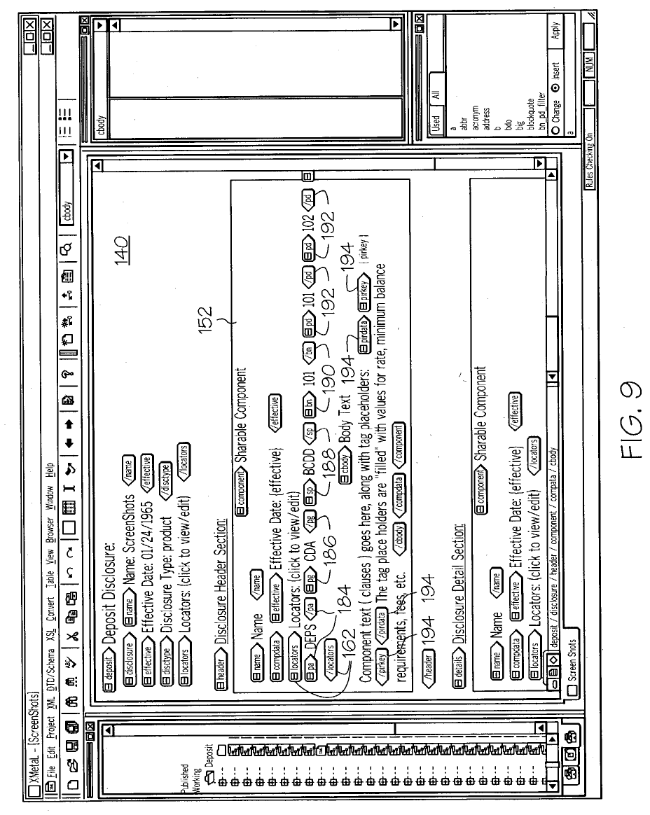

As shown in FIG. 9, once the locators values have been selected in box 168 for component 152, the locator values appear within locators tags 162. In this instance, tags 184 indicate product area, tags 186 product group, tags 188 subproduct code, tags 190 bank number and tags 192 pricing districts. The body text appearing within tags 164 includes tag place holders 194 that are filled with appropriate financial values for rates, minimum balance requirements, fees and the like.

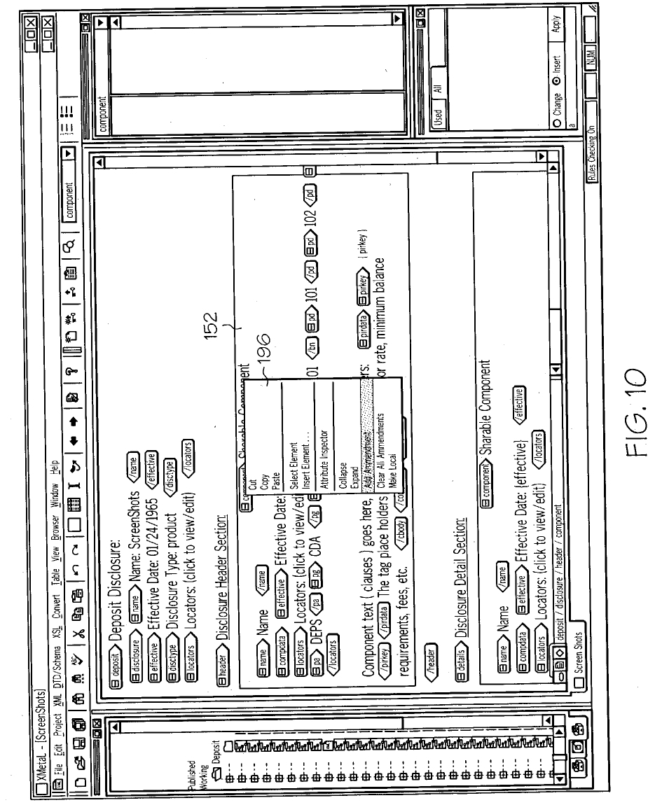

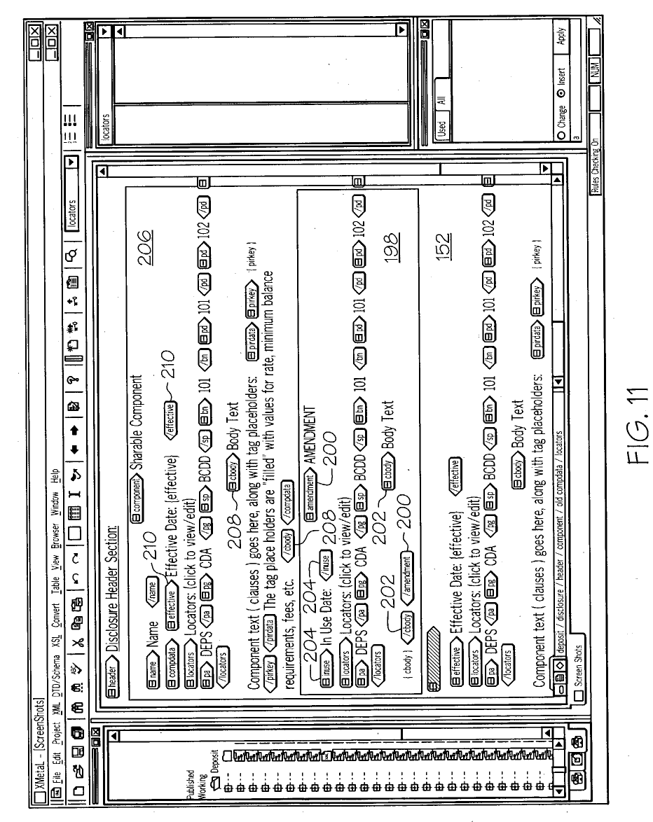

An editor can change the content of a component as described above, or the editor can create an amendment within a component. An amendment is used to create a text clause that will be used to notify recipients of upcoming changes in such items as fees, rates and the like. FIG. 10 shows the procedure for creating an amendment within a component 152. The editor right clicks on the desired component in order to display a menu 196. The command “add amendment” is selected from menu 196. As shown in FIG. 11, in response to selection of “add amendment,” amendment section 198 appears. Section 198 includes the same tags as in component 152 above it. Consequently, locators and text may be applied within section 198 in the same fashion as the are in component 152. In this way once created, a component (such as component 152) is not itself changed. In order to change the text clause of the completed disclosure document to which a component relates, it is necessary to create an amendment (shown within tags 200 in section 198) having amended text (within tags 202) that will temporarily appear with component 152 upon the “in use date” shown within tags 204. Section 198 is used to notify the recipients of the disclosure document of upcoming changes. It should be noted that the amendment of section 198 will thus become used and shown on the in use date for any disclosure documents to be used in the product areas, product groups, subproduct codes, and pricing districts indicated in the section 198 along with component 152. Component 206 contains the new body text appearing within tags 208 that will replace the text from clauses 152, 198 on the “effective date” within tags 210.

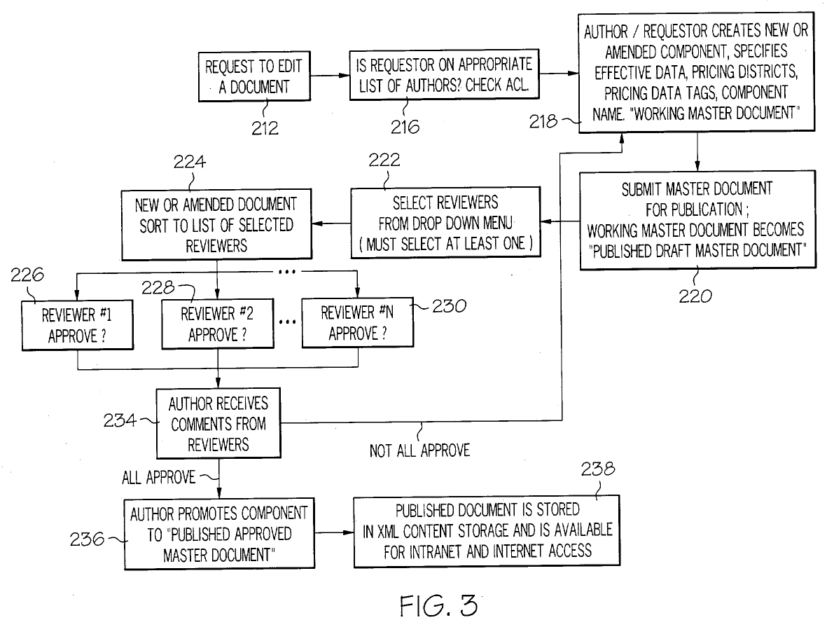

The process for approving and publishing a changed component is shown schematically in FIG. 3. This process utilizes Java servlets located on application server 20 (see FIG. 1) to perform the action required by the user through the web browser interface 18. As shown in box 212, using the editing software, an editor requests permission to edit a particular component. An editor may interface with the editing software, which is resident on library server 30, by means of computer 214 (see FIG. 1). The request is then processed, as shown in box 216, during which the editor (or author of a newly created document) is compared to the list of permissible editors for that particular clause in an access control list (“ACL”). If the editor is on the permitted ACL, as shown in box 218 the editor or author creates a new or amended component and specifies the effective date, pricing districts, pricing data tags, component name and the like, through the process described in FIGS. 7-11 and accompanying text. At this time, the component is within a “working master document” and thus is unavailable for intranet or Internet access. As indicated in box 220, the author then submits the published draft master document to reviewers. As shown in box 222, the author selects from a list of reviewers a subset of reviewers for the new or amended component. The system is programmed to require that a published draft master document be sent to at least one reviewer. Reviewers may include representatives from the legal department, product managers, systems personnel and marketing personnel. The new or amended master document is sent to the reviewers, as indicated in box 224. The reviewers are shown schematically in boxes 226, 228 and 230. The reviewers may interface with the system by means of networked computers 232 that communicate with library server 30.

It is important to note that the edited component is sent to reviewers 226-230 simultaneously so that all reviewers have an opportunity to begin the review process at the same time. In the event that all reviewers 226-230 approve of the amended text, as shown in box 234, the author receives comments and, as shown in box 236, promotes the published draft master document to a “published approved document” and it is stored as an intranet and Internet accessible document in XML content in database 34 (see FIG. 1), as shown in box 238. However, if one or more reviewers disapprove of an amended component and have comments, then, as shown in box 234, the author then incorporates the comments into a revised working master document, shown in box 218. The revised, amended component is then re-sent to reviewers 226-230 for review and approval. This process is iterative in nature and, at such time as all reviewers 226-230 approve, the component is then stored as a published approved document as indicated box 238. The system has the added flexibility to enable an author to stop the work flow if a response is not received in a timely manner from a reviewer and to vary the subgroup of reviewers with each iteration.

An additional capability of the present invention is that an editor can request an electronic form that contains locator and body text information of the amendments of a disclosure document, such as the text within tags 202 of section 198 (see FIG. 11). An editor can cut and paste information from the request form to a word (e.g., Microsoft Word) document and transmit that document to the statement preparation group, where that body text would be sent to current customers of that particular product to advise them of an upcoming change.

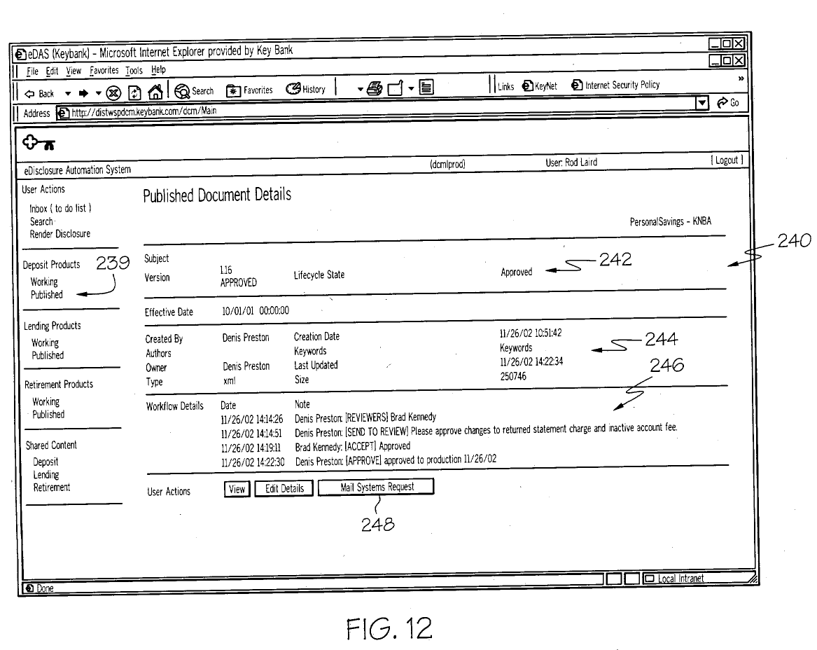

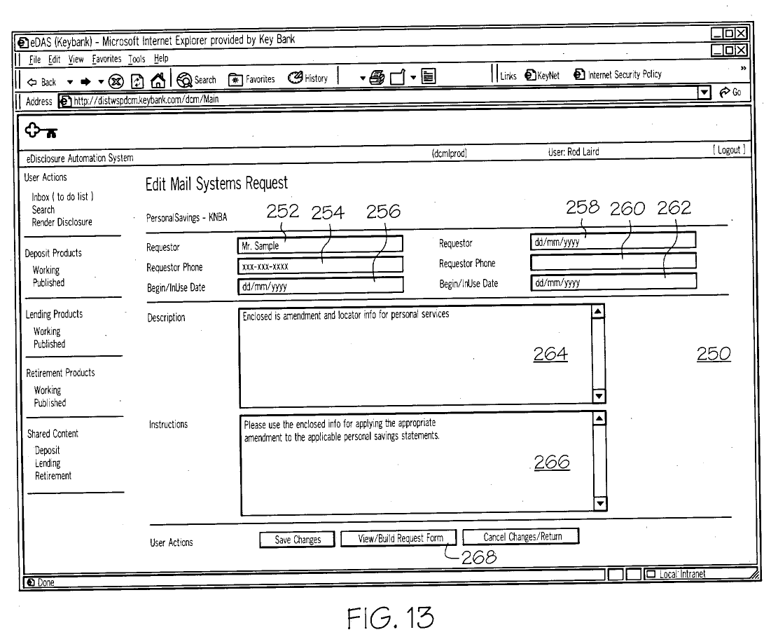

As shown in FIG. 12, an editor of a master document may inform the statement preparation group of an upcoming change to a disclosure document so that the statement preparation group can communicate the change to current users of the bank product to which the changed disclosure pertains. Editor terminal 214 (FIG. 1) communicates with application server 20 through web server 18. The editor first selects the master document from a published document list, generated by activating the “Published” link 239, and views screen 240. Screen 240 includes information concerning the state of the particular document at 242, the editors and authors of the document at 244 and the workflow details of the document at 246. The editor actuates the “Mail Systems Request” button 248 and views the screen shown in FIG. 13. The windows in screen 250 of FIG. 13 initially are empty and the editor fills them in as shown in the figure. There is a window 252 for the name of the requestor, as well as windows 254, 256, 258, 260 and 262 that pertain to information relating to the requestor and the document. There is also a window 264 that allows the editor to provide a brief description of the amendment and a window 266 that allows the editor to add instructions to the recipient of the amended document at the document preparation group.

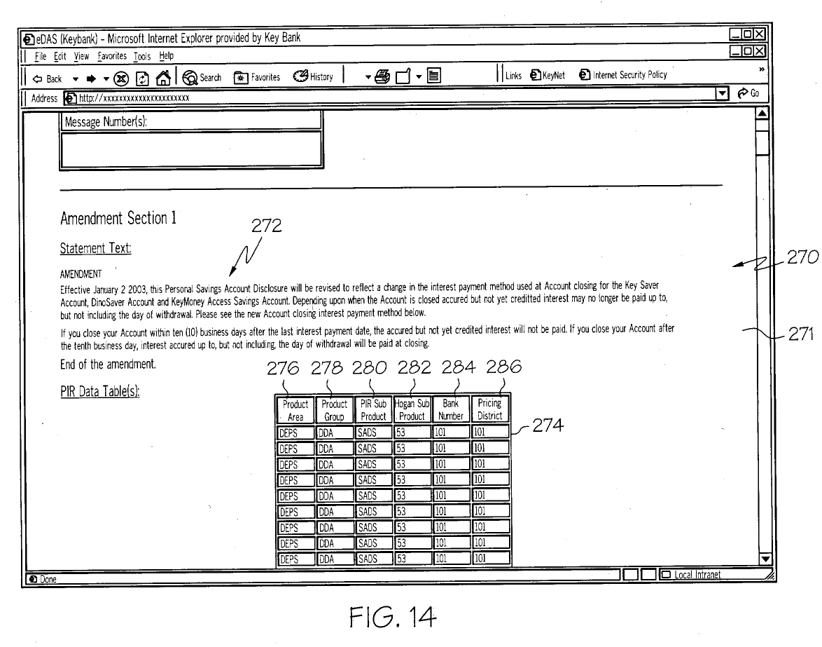

Once the windows 252-266 are filled in, the editor actuates the “View/Build Request Form” button 268 and, as shown in FIG. 14, window 270 is launched automatically. Window 270 comprises a form 271 that includes the amended text 272 and a table 274 that sets forth the product areas 276, product groups 278, PIR (pricing information repository, a database of pricing information located in database 36 (see FIG. 1)) sub-product 280, sub-products 282, bank numbers 284, and pricing districts 286. Form 271 is transmitted to and is displayed at terminal 288 at the statement preparation group. This enables the statement preparation group to send the statement text 272 to all current bank customers who use the products and reside in the regions specified in table 274. The amended text 272 may be sent as part of a bank customer's account statement either electronically, such as by electronic mail over a network such as the Internet, to computers of customers or by mail or other document delivery service to customers. This added capability allows a bank to reuse the amendment created for new customers as notification of upcoming changes to current customers.

Consequently, the editing process enables changes to be made to specific components, but only by pre-approved individuals who qualify as editors. Once such a component is amended, upon the effective date of that amendment, that component is automatically selected and incorporated into disclosure documents to which that amended component pertains. The amendment process includes the flexibility to amend not only the specific text of a clause, but also the pricing districts or geographic districts to which it pertains.

While the system and methods herein described constitute preferred embodiments of this invention, it is to be understood that the invention is not limited to these precise systems and processes, and that changes may be made therein without departing from the scope of the invention.

What is claimed is:

1. A process for automatically creating a financial document pertaining to a financial product, in which all clauses present therein are effective, comprising the steps of:
providing a computer database including at least one master financial document pertaining to a specific financial product, said master financial document having a plurality of clauses, each of said clauses containing information associated with a different one of a plurality of geographic regions;
selecting said master financial document associated with said specific financial product from said database;
providing information regarding a desired one of said plurality of geographic regions; and
selecting from among said clauses all document clauses pertaining to said desired region to be used in said selected master financial document and assembling said selected clauses into said document to make a completed, unitary financial document.

2. The process of claim 1 including the step of displaying said completed financial document to a party.

3. The process of claim 2 wherein said party is a party requesting said financial product.

4. The process of claim 1 wherein said step of providing a computer database including at least one master financial document includes providing a plurality of master financial documents, each of said plurality of mater financial documents pertaining to a different one of a plurality of different types of financial products.

5. The process of claim 1 wherein the step of selecting all document clauses includes the steps of:
retrieving all document clauses from said computer database of document clauses that pertain to said selected master financial document for all of said regions;
selecting from said retrieved document clauses a subset of clauses that are appropriate for said desired region; and
assembling said subset of clauses into said selected master financial document to make said unitary document.

6. The process of claim 1 further comprising the steps of:
providing a database of financial value information pertaining to said plurality of regions and said retrieving financial value information pertaining to said desired region from a database of financial value information for said plurality of regions; and
inserting said financial value information into selected ones of said clauses of said document.

7. The process of claim 1 wherein said step of providing a computer database of document clauses includes the step of providing each of said document clauses with a tag identifying an effective date for said clause to be included in said master document.

8. The process of claim 1 wherein said step of providing a computer database of document clauses includes the step of providing each of said document clauses with a tag identifying said master document to which it pertains.

9. The process of claim 1 wherein said step of providing a computer database of document clauses includes the step of providing each of said document clauses with a tag identifying one of a plurality of product areas.

10. The process of claim 1 wherein said step of providing a computer database of document clauses includes the step of providing each of said document clauses with a tag identifying one of a plurality of product groups.

11. The process of claim 1 wherein said step of providing a computer database of document clauses includes the step of providing each of said document clauses with a tag identifying one of a plurality of sub-product groups.

12. The process of claim 1 wherein said step of providing a computer database of document clauses includes the step of providing each of said document clauses with a tag identifying one of plurality of bank numbers.

13. The process of claim 1 wherein said step of providing a computer database of document clauses includes the step of providing each of said document clauses with a tag identifying one of a plurality of pricing districts.

14. The process of claim 1 wherein said step of providing a computer database of document clauses includes the step of providing each of said document clauses with a tag identifying one of a plurality of term-to-maturity values.

15. The process of claim 1 wherein said step of providing a computer database of document clauses includes the step of providing each of said document clauses with a tag identifying one of a plurality of initial deposit values.

16. The process of claim 1 wherein said financial document is selected from the group consisting of a deposit product disclosure document, a lending product disclosure document, a retirement product disclosure document, an investment product disclosure document and a privacy policy statement.

17. The process of claim 1 wherein said information providing step includes the step of receiving a request for said specific financial product pertaining to said financial document.

18. The process of claim 17 wherein said request receiving step includes the step of receiving a request from a bank customer in hypertext markup language format.

19. The process of claim 17 wherein said request receiving step includes the step of receiving a request from a bank branch in hypertext markup language format.

20. A process for automatically creating a financial document pertaining to a financial product, in which all clauses present therein are effective, comprising the steps of:
providing a computer database including a plurality of master financial documents, each of said plurality of master financial documents pertaining to a different one of a plurality of different types of financial products, said master financial documents each having a plurality document clauses, each of said clauses containing information associated with a different one of a plurality of geographic regions;
selecting said master financial document associated with said specific financial product from said database;
providing information regarding a desired one of said plurality of geographic regions;
retrieving all document clauses from said computer database of document clauses that pertain to said selected master financial document for all of said geographic regions;
selecting from said retrieved document clauses a subset of clauses that are appropriate for said desired geographic region; and
assembling said subset of clauses into said selected master financial document to make a completed, unitary financial document.

21. A system for automatically creating financial documents pertaining to a financial product, in which all clauses present therein are effective, comprising:
a computer database including at least one master financial document pertaining to a specific financial product, said master financial document having a plurality of document clauses, each of said clauses containing information associated with a different one of a plurality of geographic regions; and
a server having an application thereon for communicating with said master financial document database and for receiving a request for said financial document customized for a particular geographic region, whereby in response to said request said application calls up said master financial document and said document clauses and assembles said document from selected ones of said clauses to make a completed, unitary financial document.

22. The system of claim 21 wherein said application is adapted to call up all clauses pertaining to said master document from said database and select a subset of said clauses therefrom that are appropriate for said region.

23. The system of claim 22 wherein said application is adapted to assemble said subset of clauses into said master document.

24. The system of claim 22 wherein said application is adapted to select said subset of clauses in part by reading at least one tag associated therewith indicating an effective date.

25. The system of claim 21 wherein said document clauses each includes a tag identifying one of a plurality of product areas.

26. The system of claim 21 wherein said document clauses each includes a tag identifying one of a plurality of product groups.

27. The system of claim 21 wherein said document clauses each includes a tag identifying one of a plurality of sub-product groups.

28. The system of claim 21 wherein said document clauses each includes a tag identifying one of a plurality of bank numbers.

29. The system of claim 21 wherein said document clauses each includes a tag identifying one of a plurality of pricing districts.

30. The system of claim 21 wherein said document clauses each includes a tag identifying one of a plurality of term-to-maturity values.

31. The system of claim 21 wherein said document clauses each includes a tag identifying one of a plurality of initial deposit values.

32. The system of claim 21 wherein said financial document is selected from the group consisting of a deposit product disclosure document, a lending product disclosure document, a retirement product disclosure document, an investment product disclosure document and a privacy policy statement.

33. The system of claim 21 wherein said application is adapted to receive a request for said specific financial product pertaining to said financial document from a bank customer over a non-proprietary network.

34. The system of claim 21 wherein said application is adapted to receive a request for said specific financial product pertaining to said financial document from a bank branch.

35. The system of claim 21 wherein said application is adapted to receive a request for said specific financial product pertaining to said financial document in hypertext markup language.

36. A system for automatically creating financial documents pertaining to a financial product, in which all clauses present therein are effective, comprising:
a computer database including a plurality of master financial documents, each of said plurality of master financial documents pertaining to a different one of a plurality of different types of financial products, said master financial documents each having a plurality of document clauses, each of said clauses containing information associated with one or more of a plurality of geographic regions; and
a server having an application thereon for communicating with said master financial document database and said database of document clauses and for receiving a request for said financial document customized for a particular region, whereby in response to said request said application calls up said master financial document and all clauses pertaining to said master document from said computer database and selects a subset of said clauses therefrom that are appropriate for said region and assemble said document from said selected subset of said clauses.

37. A process for editing a financial document pertaining to a financial product comprising the steps of:
providing a computer database including at least one master financial document pertaining to a specific financial product, said master financial document having a plurality of components having document clauses, each of said components containing information associated with one or more of a plurality of geographic regions;
determining whether an editor is on an approved list of authors and if so, allowing said editor to edit said master financial document;
enabling an editor to amend one or more of said components of said master document to make an edited master financial document and storing said edited master document in said database marked as a working document such that said amended components are unavailable for use in creating said financial document;
sending said edited master financial document to a predetermined list of one or more reviewers for comments or approval;
if comments to said amended components are generated by one or more reviewers, receiving said comments from said reviewers pertaining to content of said edited master document, revising said edited components in response to said comments, re-sending said revised, edited master financial document to said reviewers for approval and repeating said comment receiving step if additional comments are received from one or more of said reviewers; and
if said revised, edited master financial document is approved by all reviewers, storing said approved, edited components marked as a published approved component available for use in constructing said financial document.

38. The process of claim 37 wherein said editing step includes the step of specifying an effective date on which said edited component will be available for use.

39. The process of claim 37 wherein said editing step includes the step of specifying a pricing district within which said edited component will be effective.

40. The process of claim 37 wherein said editing step includes specifying pricing information to be associated with said edited component.

41. The process of claim 37 wherein said editing step includes specifying a component name for said edited component.

42. The process of claim 37 wherein said step of sending said edited component to said predetermined list of one or more reviewers includes the step of sending said edited component to a plurality of reviewers substantially simultaneously.

43. The process of claim 37 wherein said step of providing a database includes providing a component having a text clause that will appear in a completed financial document.

44. The process of claim 37 comprising the additional step of notifying current users of a financial product of said amended one or more of said components.

45. The process of claim 44 wherein said notifying step includes the step of creating an electronic form that displays said amended one or more of said components.

46. The process of claim 45 wherein said creating step includes the step of displaying said electronic form to a statement preparer.

47. The process of claim 45 comprising the further step of sending copies of body text of said amended one or more of said components to said current users.

48. A process for editing a financial document pertaining to a financial product and communicating edited text thereof to current users of said financial product comprising the steps of:
providing a computer database including at least one master financial document pertaining to a specific financial product, said master financial document having a plurality of components having document clauses;
enabling an editor to amend one or more of said components of said master document;
storing said edited components marked as available for use in constructing said financial document; and
notifying current users of a financial product of said amended one or more of said components by creating an electronic form that displays said amended one or more of said components, displaying said electronic form to a statement preparer and sending copies of body text of said amended one or more of said components to said current users.
